(19) United States
(12) Patent Application Publication
(10) Pub. No.: US 2010/0256971 A1
(43) Pub. Date: Oct. 7, 2010

(54) METHOD FOR SIMULATING THE OPERATION OF A DEVICE HAVING AN ARCHITECTURE AND A PROCESSOR DETERMINED BY MEANS OF ANOTHER DEVICE CONNECTED TO A COMPUTER NETWORK

(75) Inventors: Romain Tisserand, Boulogne Billancourt (FR); David Raingeard, Lutz en Dunois (FR)

Correspondence Address: YOUNG & THOMPSON, 209 Madison Street, Suite 500, Alexandria, VA, 22314, US

(73) Assignee: DOTEMU, Montreuil (FR)

(21) Appl. No.: 12/526,423

(22) PCT Filed: Feb. 11, 2008
(86) PCT No.: PCT/FR2008/000171

§ 371 Date: Apr. 21, 2010

(30) Foreign Application Priority Data
Feb. 9, 2007 (FR) 07 00995

(51) Int. Cl. G06G 7/62

(52) U.S. Cl. 703/21

(57) ABSTRACT

A method for simulating the operation of devices having a predetermined architecture relative to devices that may have a different architecture, includes the following steps: transmission by a user client connected to a computer network of a request to a server, the purpose of the request being to access a predetermined application contained in the server; transfer from the server to the user client of the corresponding client module with the automatic integration thereof into the network browser; setting up of the client module and transmission of a request by the client module in order to obtain the transfer from the server to the user client of a portion at least of the information, data and resources included in the corresponding content file; setting up of an emulation node contained in the client module; integration of the data or resources previously transferred into the emulation node; automatic execution of the predetermined application.

The object of the present invention is a method for simulating the operation of a device having an architecture and a processor determined by means of another device connected to a computer network, such as Internet, this other device comprising a generally distinct architecture and processor. It notably, but not exclusively, applies to a method which allows emulation of a game console notably by using a web browser of a computer or of a mobile telephone.

It is known that with the increase in the data processing power of processors, it has been possible to improve the quality of emulation of hardware devices such as old game consoles, on computers or mobile telephones. With this technology, video games specific to game consoles with an obsolete architecture, may thus be run on recent multimedia and interactive terminals.

Nevertheless, the emulation of these consoles and of the associated video games generally requires:
preliminary downloading, installing and configuring of the emulator specific to a determined console;
manual downloading of said video games and their installation in the suitable emulator.

More specifically, execution of the emulated application notably requires proceeding with downloads:
of a dedicated emulator (a client module);
of at least one file required for running said emulator, such as:
   the BIOS(es) of the machine to be emulated; and/or
   the media file containing said application, this file may assume the form of an image of a hard disk, of a CDROM, of a diskette or cassette.

Now, these operations are tedious and require highly specialized skills

Further, downloading of these video games on an individual terminal has the additional drawback of giving the possibility to the user of recovering on a storage device, such as a hard disk, an image of video games which are not generally free of copyright.

More particularly, the object of the invention is therefore to solve these problems by proposing a method for emulating the operation of hardware devices, such as video game consoles, on hardware devices, generally having a distinct architecture, by means of a network browser and without it being necessary for the user to proceed with any installation and adjustment operation.

For this purpose, it proposes a method which provides simulation of the operation of devices having a determined architecture on devices which may have a distinct architecture, characterized in that it involves:
a computer terminal which comprises at least one means such as a network browser providing access to an Internet/Intranet computer network and with which pages may be viewed;
at least one server which notably includes:
   at least one client module transferable to the computer terminal, this client module comprising at least one emulation kernel which allows emulation of at least one determined application;
   an inference engine;
   at least one parameterizable “contents file”, having a specific format and which comprises the whole of the configuration information as well as the data and resources required for running the determined application to be emulated; in this way, each “contents file” comprises at least one determined application;
      and in that it comprises the carrying out of the following steps:
transmission by a client user connected to a computer network, by means of the computer terminal, of a request to the server, this request relating to accessing a determined application comprised on said server;
transfer from the server to the client-user of the corresponding client module and its automatic integration into the network browser;
initialization of the client module and transmission of a request by the client module in order to obtain the transfer from the server to the client-user, of at least one portion of said information, data and resources comprised in the corresponding “contents file”;
transfer from the server to the client-user of said information, data and resources comprised in the “contents file”;
initialization of an emulation kernel comprised in the client module, this initialization and selection of the emulation kernel being carried out on the basis of said information or data comprised in the “contents file” which have been transferred in the previous step;
integration of said data or resources having been transferred beforehand into the emulation kernel, this integration being carried out on the basis of the transmitted configuration information;
automatic execution of the determined application.

In this way, the application to be emulated is automatically executed without the user having to proceed with complex installation and adjustment operations. Moreover, the separate transmission of the emulation kernel, which is comprised in the client module, and of the data and resources required for running the emulated targeted application, notably provides better control over the use which the client user makes of this application. Indeed, the “contents file” may be parameterized so as to bring restrictions on the use of said application and notably avoid misuse of the latter which is generally subject to protection by copyright.

Advantageously, according to an alternative embodiment of the invention, in a first phase, only part of the information, data and resources comprised in the “contents file” may be transferred from the server to the client-user in order to obtain a minimum “contents file” during initialization and execution of the emulated application. Subsequently, the other data and resources required for running said application are dynamically read from the server during the emulation of this application. Thus, these other data and resources are transmitted as packets towards the computer terminal of the client user and sequentially processed upon their reception, which notably allows:
adaptation of the transmission of said packets depending on the execution state of the application. As an example, if an application is a video game, transmission of the packets will be carried out depending on the progression of the game and therefore on the actions of the player. In this way, all the packets of data forming the application to be emulated will not have to be transmitted, which limits the volume of data exchanged between the server and the computer terminal of the user client;
suppression of the waiting times which may result from downloadings of particularly voluminous files. Indeed, according to this alternative embodiment of the invention, initialization of the execution of the application may be carried out without it being necessary that all said packets have been transferred from the server to the computer terminal of the client user, this alternative being thus particularly suitable when it should proceeded with dynamical reading of data comprised on:
   a mass medium such as CDROM or a hard disk; or
   on read-only memory which may be of the EEPROM type;
reduction or even suppression of the storage constraints of the application to be emulated on the computer terminal of the client user. Indeed, the packets comprising the data and resources which allow execution of this application may be volatile and be treated by the emulation kernel sequentially without requiring storage on a mass memory such as a hard disk, which further allows a reduction of the traces of the image of said application on the computer terminal of the client user.

Preferentially, in order to reduce the traces of the image of said application on the computer terminal of the client user, the constitutive elements of said emulation kernel will not be stored permanently on a mass memory such as a hard disk.

Advantageously, according to another alternative embodiment of the invention, in order to optimize the control of the image of the application to be emulated, each resource, datum, configuration information comprised in the “contents file” may be cut into blocks, and each of these blocks may be encrypted by using an algorithm and a different key.

According to an alternative embodiment of the invention, the inference engine may generate a specific “contents file” depending on the nature of the initial request of the user client.

Advantageously, the method according to the invention allows several clients-users to access and use the same application on the network by applying a network connectivity module comprised on the server, this module making multi-user synchronization possible.

An embodiment of the invention will be described hereafter, as a non-limiting example, with reference to the appended drawings wherein:

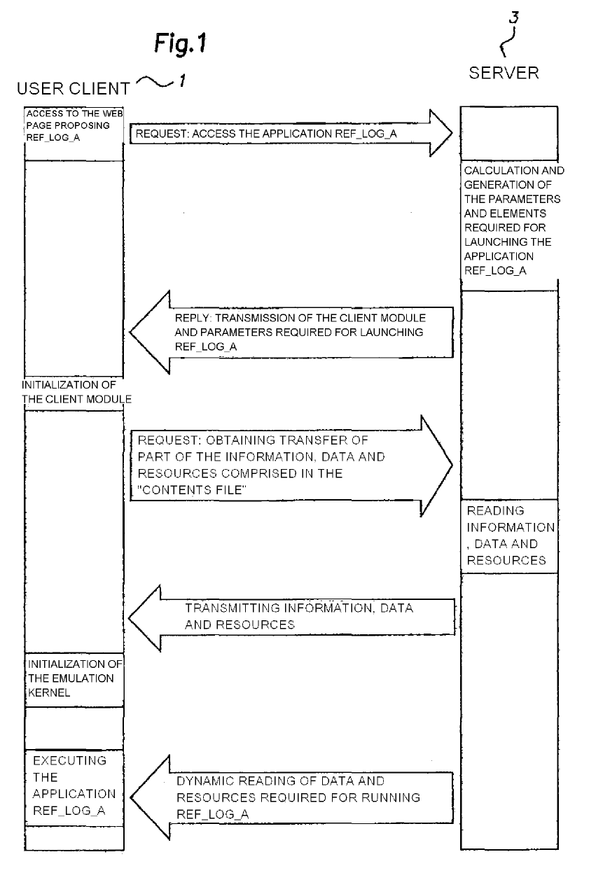

FIG. 1 is a schematic illustration of the method according to the invention in the form of a flowchart showing the exchanges between the client-user and the server.

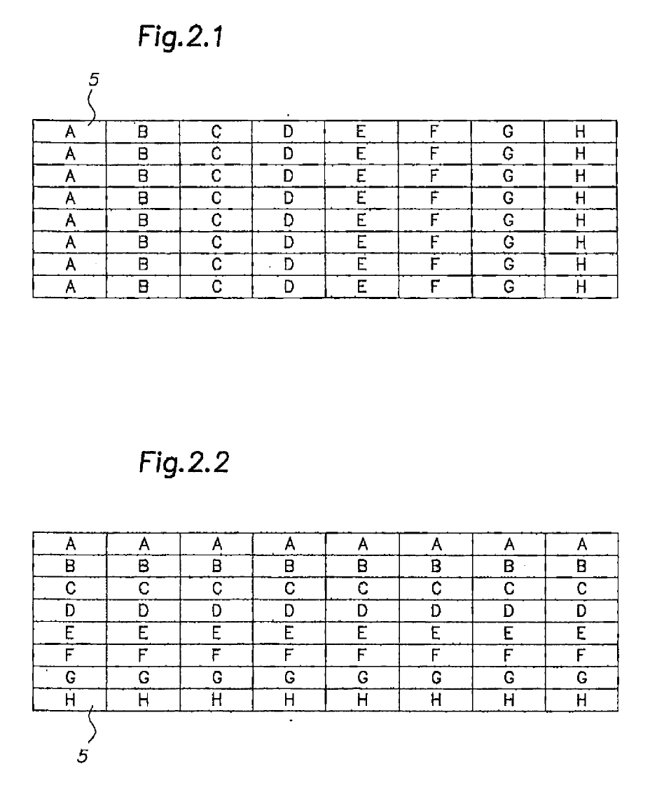

FIG. 2 is a schematic representation of different types of organization of graphic data of the application to be emulated.

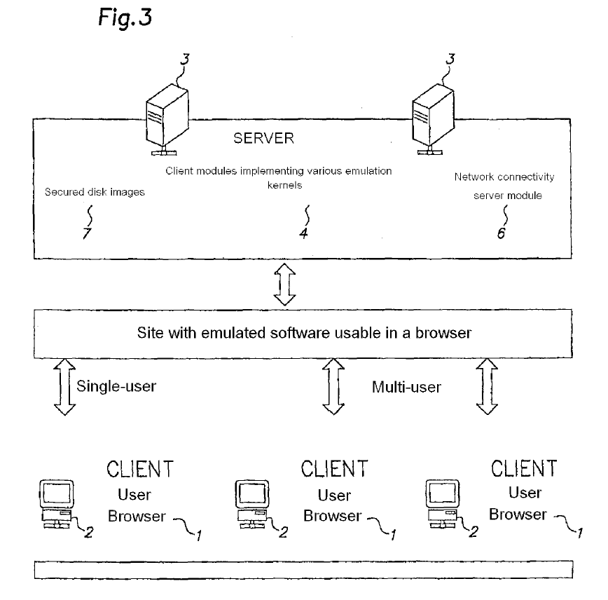

FIG. 3 is a schematic illustration as a flowchart of the structure of the device required for applying the method according to the invention.

In this example, said method comprises the carrying out of the following steps:
transmission by a client-user 1 connected to a computer network, by means of a computer terminal 2 equipped with a network browser, of a request to a server 3, this request relating to accessing a determined application (REF_LOG_A) comprised on said server 3. Thus, as an example, the client-user 1 equipped with a computer terminal 2 may access a Web page by means of an Internet browser and select in a list of video games, the one which is of interest to him/her, this selection being expressed by automatic transmission of the request of the aforesaid type to the server 3;
calculation and generation by an inference engine comprised in the server 3 of the parameters and elements required for launching the determined application (REF_LOG_A), these parameters may notably but not exclusively be:
   the address where a client module 4 appears on the server 3, which notably comprises an emulation kernel which may emulate said application (REF_LOG_A); and/or
   identifiers of software components (for example a video game) and hardware components (for example a video game console) to be simulated, these identifiers allow these components to be located in a structured and indexable means such as a database, comprised in the server 3; and/or
   information concerning the client-user 1, i.e. for example, his/her name and password which may be encrypted; and/or
   data relating to the display, to sound inputs, to user inputs (the latter may relate to inputs of the keyboard, mouse, joystick type, etc.);
      said elements as for them may notably be formed by a “contents file” having a specific format which comprises the whole of the configuration information as well as the data and resources required for initializing and operating the determined application (REF_LOG_A) to be emulated in the Internet browser, this “contents file” may comprise:
media files which may assume the form of “disk images” such as of cassettes, hard disks, CD-ROMs; and/or
media files which may assume the form of read-only memory images such as EEPROM images;
optionally at least one script which may be interpreted by the client application onboard the Internet browser;
a pre-saved state of the starting state of the application to be simulated (REF_LOG_A);
transmission by the server 3 to the client-user 1 of said parameters;
transfer from the server 3 to the client-user 1 of the client module 4 and its automatic integration into the network browser, the client module 4 being produced in a technology compatible with the integration requirement in such a browser (for example, this may be a Java® applet or a Flash® module);
initialization of the client module 4 and transmission of a request by the latter 4 in order to obtain transfer from the server to the client-user 1 of part of said information, data and resources comprised in the corresponding “contents file”. This information which allows automatic execution of the determined application (REF_LOG_A) notably relates to the size of each packet forming the application (REF_LOG_A) as well as to the number of these packets;
reading by the inference engine server 3 of said information, data and resources comprised in the “contents file” and which are relative to the image 7 of the determined application to be emulated (REF_LOG_A) present on the server 3;
transmission by the server 3 to the client-user 1 of a response comprising said information, data and resources comprised in the “contents file”;
automatic initialization of the emulation kernel comprised in the client module 4, this initialization as well as the selection of the emulation kernel, being carried out on the basis of said information or data comprised in the “contents file” which have been transferred beforehand;
integration of said data or resources transferred beforehand into the emulation kernel, this integration being carried out on the basis of transmitted configuration information;
execution of the determined application (REF_LOG_A).

In this way and advantageously, it is possible for a client-user 1 to initialize an emulated application (REF_LOG_A), with a simple mouse click while disregarding problems of downloading, installation and configuration of the emulation kernel. Indeed, the application of the steps of the method according to the invention which follow the initial step may be carried out without the client-user 1 having to perform any configuration action.

Thus, the client-user 1 may initialize the application of the method according to the invention by selecting a simple HTML link on a WEB page, this link may correspond to the selection of the application to be emulated (REF_LOG_A).

Advantageously, the “contents file” may be cut up into packets. In this way, after initialization of the application to be emulated (REF_LOG_A), the packets required for executing this application may be transmitted “on the fly” from the server 3 to the client-user 1 in a unitary way, this notably allowing dynamic reading from the server 3 of the corresponding data and resources which are required for running said application (REF_LOG_A).

Moreover, the inference engine may generate, during the second step of this method, a specific “contents file” depending on the nature of the initial request of the client-user 1. Thus, depending on the selection by the client-user 1 of the application to be emulated (REF_LOG_A), the inference engine will generate a specific “contents file” notably comprising the whole of the configuration information as well as the data and resources required for operating this application (REF_LOG_A).

According to an alternative embodiment of the invention, the “contents file” may be generated by a physical person and then be loaded on said server 3. In this way, the server 3 comprises a “contents file” for each application to be emulated (REF_LOG_A).

Advantageously, this “contents file” may be parameterized in order to better control the use that the client-user 1 may make of the application to be emulated (REF_LOG_A). Thus, upon generating a “contents file”, it is possible to notably proceed with parameterizations:
of the expiry date of the “contents file”: thus, if this date is exceeded, the “contents file” is no longer utilizable on the server 3; and/or
of the maximum emulation time of the “contents file”: when this time has elapsed, the client-user 1 is informed that he can no longer use the emulated application (REF_LOG_A) stored in the “contents file”; and/or
of the domain name on which the “contents file” is functional.

It is also possible to indicate upon generating the “contents file”, the regional characteristics which the operating system should have present in the computer terminal 2 of the client-user 1 so that the application to be emulated (REF_LOG_A) may be executed on said computer terminal 2. As an example, if the “contents file” is used by a computer terminal 2, equipped with a French operating system while it was indicated that this “contents file” can only be used on a computer terminal 2 equipped with an American operating system, said “contents file” cannot be executed.

Further, each resource, datum, configuration information comprised in the “contents file” may be cut up into blocks, and each of the blocks may be encrypted by using an algorithm and a different key.

The graphic data of the application to be emulated (REF_LOG_A) which are often of very different formats, are saved on the server 3 in a first specific format adapted to the original hardware to be simulated, these graphic data being comprised in a “contents file”. In order to make them more accessible and to thereby optimize the performances of the emulated GPU (Graphics Processing Unit-graphic chip), these graphic data may advantageously be transformed by decoding into a second format which is more suitable for proceeding with an emulation of the aforesaid type, these data being then recorded in a buffer memory, in order to avoid having to again proceed with their decoding.

Thus, as this is illustrated in FIG. 2, the graphic data of a same type of data (A, B, C, . . . ) are initially organized in columns in memory cells 5 (FIG. 2.1), which corresponds to a planar organization of the data and is suitable for the original hardware to be simulated. If they are necessary, these graphic data, after transformation by the decoding, are reorganized linearly, (a same type of data is arranged in a line) and recorded in a cache memory (FIG. 2.2) in order to optimize the emulation process.

Depending on the GPU to be simulated, said cache memory may have the following specificities:
the cache memory may correspond to a buffer memory having a significant size so as to be able to comprise all the displayable primitives, this solution being preferred when the number of graphic primitives is limited and when the memory capacity of the computer terminal of the client-user 1 is sufficiently large;

or
the cache memory may be of the LRU (Least Recently Use) type with which only the most used graphic data may be put into cache memory, while allowing said cache not to exceed a limiting size, this solution being adapted when the computer terminal 2 of the client-user 1 comprises very little random memory and requires more processing power than in the previous case.

As this is illustrated in FIG. 3, the device required for applying the method according to the invention comprises:
at least one interactive and multimedia computer terminal 2 (computer, PDA, telephone, etc.) provided with peripherals:
   multimedia output devices such as a screen;
   man/machine input and/or interaction devices such as a keyboard, a mouse, a joystick, a touch screen;
   means for transmission with at least one Internet/Intranet site such as notably a browser and a network connection supported by a specific communications protocol independent of the network protocol which it utilizes, preferentially, if the connection up to the client-user 1 allows it, the underlying UDP network protocol is preferred by default, the TCP protocol is used;
at least one server 3 of the Internet type at least partly accessible via said Internet/Intranet site, this server 3 including:
   at least one client module 4 transferable to the computer terminal 2, this client module 4 comprises at least an emulation kernel providing emulation of at least one determined application (REF_LOG_A) and also a means for saving and restoring a complete state of the emulated system at any moment by an action from the client-user 1;
   an inference engine (not shown) notably proceeding:
      with calculating and generating parameters and elements required for launching a determined application (REF_LOG_A);
      with reading information, data and resources concerning the “contents file” comprising the image 7 of the determined application (REF_LOG_A);
      with managing the transmission to the client module 4 integrated in the computer terminal 2 of the client-user 1 of the packets forming the “contents file” and therefore the determined application (REF_LOG_A);
   at least one parametrizable “contents file” (not shown), having a specific format and which comprises the whole of the configuration information as well as the data and resources required for running the determined application (REF_LOG_A) to be emulated.

According to an alternative embodiment of the invention, the device required for applying the method of the invention may also include:
at least one means for persistent storage in memory of the data comprised on the server 3, these data may notably be information relative to the state of the emulated application (REF_LOG_A) such as screen captures, to a state of the random memory, a state of the video memory, a state of the EEPROM memory, the best scores in the case when this application (REF_LOG_A) is a video game; and/or
a network connectivity module 6 comprised on the server 3 allowing several clients-users 1 to access and use on a network the same application (REF_LOG_A), this module 6 which makes multi-user synchronization possible, is of a certain interest in the case when the emulated application (REF_LOG_A) is formed by a game console/video game set.

Advantageously, according to an alternative embodiment of the invention, this multi-user synchronization of the same application (REF_LOG_A) may be achieved by means of peer-to-peer technology, the computer terminals 2 of different clients-users 1 directly communicating with each other without resorting to such a network connectivity module 6.

1. A method which allows simulation of the operation of devices having a determined architecture on devices which may have a distinct architecture, characterized in that it involves:
a computer terminal (2) which comprises at least one means such as a network browser providing access to a computer network Internet/Intranet and with which pages may be viewed;
at least one server (3) which notably includes:
at least one client module (4) transferable to the computer terminal (2), this client module (4) comprising at least one emulation kernel which allows emulation of at least one determined application (REF_LOG_A);
an inference engine;
at least one parameterizable “contents file”, having a specific format and which comprises the whole of the configuration information as well as the data and resources required for running the determined application (REF_LOG_A) to be emulated;
and in that it comprises the carrying out of the following steps:
transmission by a user client (1) connected to a computer network, by means of the computer terminal (2), of a request to the server (3), this request relating to accessing a determined application (REF_LOG_A) comprised on said server (3);
transfer from the server (3) to the client-user (1) of the corresponding client module and its automatic integration into the network browser;
initialization of the client module (4) and transmission of a request by the client module (4) in order to obtain the transfer from the server (3) to the client-user (1), of at least one portion of said information, data and resources comprised in the corresponding “contents file”;
transfer from the server (3) to the client-user (1) of said information, data and resources comprised in the “contents file”;
initialization of an emulation kernel comprised in the client module (4), this initialization and selection of the emulation kernel being carried out on the basis of said information or data comprised in the “contents file” which have been transferred in the previous step;
integration of said data or resources having been transferred beforehand into the emulation kernel, this integration being carried out on the basis of the transmitted configuration information;
automatic execution of the determined application (REF_LOG_A).

2. The method according to claim 1, characterized in that it comprises the carrying-out of the following steps:
transmission by a client-user (1) connected to a computer network, by means of a computer terminal (2) equipped with a network browser, of a request to a server (3), this request relating to accessing a determined application (REF_LOG_A) comprised on said server (3);
calculation and generation by an inference engine comprised in the server (3) of the parameters and elements required for launching the determined application (REF_LOG_A), these parameters may be:
the address where a client module (4) appears on the server (3), notably comprising an emulation kernel which may emulate said application (REF_LOG_A);
identifiers of software and hardware components to be simulated, these identifiers allowing these components to be located in a structured and indexable means such as a database, comprised in the server (3);
information concerning the client-user (1);
data relating to the display, to sound inputs, to user inputs;
said elements as for them may notably be formed by a “contents file”;
transmission by the server (3) to the client-user (1) of said parameters;
transfer from the server (3) to the client-user (1) of the client module (4) and its automatic integration into the network browser, the client module (4) being produced in a technology compatible with the requirement of integration into such a browser;
initialization of the client module (4) and transmission of a request by the latter (4) in order to obtain transfer from the server to the client-user (1) of part of said information, data and resources comprised in the corresponding “contents file”, this information which allows automatic execution of the determined application (REF_LOG_A) notably relating to the size of each packet forming the application (REF_LOG_A) as well as to the number of these packets;
reading by the inference engine of the server (3) of said information, data and resources comprised in the “contents file” and which are relative to the image (7) of the determined application to be emulated (REF_LOG_A) present on the server (3);
transmission by the server (3) to the client-user (1) of a reply comprising said information, data and resources comprised in the “contents file”;
automatic initialization of the emulation kernel comprised in the client module (4), this initialization as well as the selection of the emulation kernel, being carried out on the basis of said information or data comprised in the “contents file”, which have been transferred beforehand;
integration of said data or resources transferred beforehand into the emulation kernel, this integration being carried out on the basis of transmitted configuration information;
execution of the determined application (REF_LOG_A).

3. The method according to claim 2, characterized in that the “contents file” comprises:
media files which may assume the form of “disk images” such as cassettes, hard disks, CD-ROMs;
media files which may assume the form of read-only memory images such as EEPROM images;
at least one script which may be interpreted by the client application onboard the Internet browser;
a pre-saved state of the starting state of the application to be simulated (REF_LOG_A).

4. The method according to claim 2,
characterized in that the parameters required for launching the determined application (REF_LOG_A) are:
the address where a client module (4) appears on the server (3), notably comprising an emulation kernel which may emulate said application (REF_LOG_A);
identifiers of software and hardware components to be simulated, these identifiers allowing these components to be located in a structured and indexable means such as a database, comprised in the server (3);
information concerning the client-user (1);
data relating to the display, to sound inputs, to user inputs.

5. The method according to claim 2, characterized in that the information which allows automatic execution of the determined application (REF_LOG_A) notably concerns the size of each packet forming the application (REF_LOG_A) as well as the number of these packets.

6. The method according to claim 1,
characterized in that its initialization is achieved by selecting a simple HTML link on a WEB page.

7. The method according to claim 1,
characterized in that the “contents file” is cut up into packets.

8. The method according to claim 7, characterized in that after initialization of the application to be emulated (REF_LOG_A), the packets required for executing this application are transmitted “on the fly” from the server (3) to the client-user (1) in a unitary way, this notably allowing dynamic reading from the server (3) of corresponding data and resources which are required for running said application (REF_LOG_A).

9. The method according to claim 7,
characterized in that in a first phase, only part of the information, data and resources comprised in the “contents file” is transferred from the server (3) to the client-user (1) in order to obtain a minimum “contents file” upon initialization of the execution of the emulated application; subsequently, the other data and resources required for running said application are read dynamically from the server (3) during emulation of this application, thus, these other data and resources are transmitted as packets towards the computer terminal (2) of the client-user (1) and processed sequentially.

10. The method according to claim 7,
characterized in that the packets comprising data and resources which allow execution of this application are volatile and are processed by the emulation kernel sequentially without requiring storage on mass memory.

11. The method according to claim 2,
characterized in that the inference engine generates, during the second step of said method, a specific “contents file” depending on the nature of the initial request from the client-user (1).

12. The method according to claim 2,
characterized in that the “contents file” is generated by a physical person and then is loaded on said server (3).

13. The method according to claim 11,
characterized in that the “contents file” is parameterized in order to better control the use that the client-user (1) may make of the application to be emulated (REF_LOG_A), it is thus possible to notably proceed with parameterizations:
of the expiry date of the “contents file”: if this date is exceeded, the “contents file” is no longer utilizable on the server (3); and/or
of the maximum emulation time of the “contents file”: when this time has elapsed, the client-user (1) is informed that he can no longer use the emulated application (REF_LOG_A) stored in the “contents file”; and/or
of the domain name on which the “contents file” is functional.

14. The method according to claim 11,
characterized in that during the generation of the “contents file”, the regional characteristics which the operating system should have present on the computer terminal (2) of the client-user (1) are indicated so that the application to be emulated (REF_LOG_A) may be executed on said computer terminal (2).

15. The method according to claim 1,
characterized in that each resource, datum, configuration information comprised in the “contents file” is cut up into blocks, and each of these blocks may be encrypted by using an algorithm and a different key.

16. The method according to claim 1,
characterized in that the graphic data of the application to be emulated (REF_LOG_A) are saved on the server (3) in a first specific format adapted to the original hardware to be simulated, these graphic data being comprised in a “contents file”; in order to make them more accessible and to thereby optimize the performances of the emulated GPU (Graphics Processing Unit), these graphic data are transformed by decoding into a second format which is more suitable for proceeding with an emulation of the aforesaid type, these data being then recorded in a buffer memory in order to avoid having to again proceed with their decoding.

17. The method according to claim 16, characterized in that the graphic data of a same type of data (A, B, C, . . . ) are initially organized as a column in memory cells (5), which corresponds to a planar organization of the data and is suitable for the original hardware to be simulated, if they are required, these graphic data, after transformation by decoding, are reorganized linearly and recorded in a cache memory in order to optimize the emulation process.

18. The method according to claim 17, characterized in that, depending on the GPU to be simulated, said cache memory has the following specificities:
the cache memory corresponds to a buffer memory having a large size in order to be able to comprise the displayable primitives; or
the cache memory is of the LRU (Least Recently Used) type which only allows the most used graphic data to be put into cache memory, while allowing said cache to not exceed a limiting size.

19. A device for applying the method according to claim 1,
characterized in that it comprises:
at least one interactive and multimedia computer terminal (2) provided with peripherals:
with multimedia outputs such as a screen;
with man/machine input and/or interaction such a keyboard, a mouse, a joystick, a touch screen;
with means for transmission with at least one Internet/Intranet site such as notably a browser and a network connection supported by a specific communications protocol independent of the network protocols which is utilizes;
at least one server (3) of the Internet type at least partly accessible via said Internet/Intranet site, this server (3) including:
at least one client module (4) transferable to the computer terminal (2), this client module (4) comprises at least one emulation kernel allowing emulation of at least one determined application (REF_LOG_A) and also a means for saving and restoring a complete state of the emulated system at any moment through an action of the client-user (1);
an inference engine notably proceeding:
with calculating and generating parameters and elements required for launching a determined application (REF_LOG_A);
with reading information, data and resources concerning the “contents file” comprising the image (7) of the determined application (REF_LOG_A);
with managing the transmission to the client module (4) integrated in the computer terminal (2) of the client-user (1) of packets forming the “contents file” and therefore the determined application (REF_LOG_A);
at least one parameterizable “contents file” having a specific format and which comprises the whole of the configuration information as well as the data and resources required for running the determined application (REF_LOG_A) to be emulated.

20. The device according to claim 19, characterized in that its includes:
at least one means for persistent storage in memory of the data comprised on the server (3), these data may notably be information relating to the state of the emulated application (REF_LOG_A) such as screen captures, a state of random memory, a state of video memory, a state of EEPROM memory, the best scores in the case when this application (REF_LOG_A) is a video game; and/or
a network connectivity module (6) comprised on the server (3) allowing several clients-users (1) to access and use on the network the same application (REF_LOG_A), this module (6) making multi-user synchronization possible.

21. The device according to claim 20, characterized in that the multi-user synchronization of the same application (REF_LOG_A) is achieved by means of peer-to-peer technology, the computer terminals (2) of the different clients-users (1) directly communicating with each other without resorting to a network connectivity module (6).
